(19) United States
(12) Patent Application Publication
(10) Pub. No.: US 2026/0258687 A1
(43) Pub. Date: Sep. 3, 2026

(54) FOLDABLE-DOOR HINGE AND FUNCTIONAL ENTITY WITH A FOLDABLE DOOR

(71) Applicant: HAWA SLIDING SOLUTIONS AG, Mettmenstetten (CH)

(72) Inventors: Yanik SIGRIST, Mettmenstetten (CN); Bastian DROOFF, Troisdorf (DE); Jens BOHNER, Bonn (DE); Roman PYSCHIK, Remscheid (DE)

(73) Assignee: HAWA SLIDING SOLUTIONS AG, Mettmenstetten (CH)

(21) Appl. No.: 18/871,327

(22) PCT Filed: Jun. 1, 2023
(86) PCT No.: PCT/EP2023/064761

§ 371 Date: Dec. 3, 2024

(30) Foreign Application Priority Data
Jul. 1, 2022 (EP) 22182691.0

(51) Int. Cl. E05D 11/00; E05D 15/26; E05D 15/58

(52) U.S. Cl. CPC E05F 1/1207; E05D 11/0054; E05D 15/26; E05D 15/58; E05Y 2800/21

(57) ABSTRACT

The foldable-door hinge includes a first hinge lever, a second hinge lever, a hinge shaft and a drive spring. The first hinge lever end piece includes two first and second inner bearing arms and two first and second outer bearing arms spaced apart from the inner bearing arms. The drive spring includes two spring packets which enclose the hinge axis and which are interconnected by a spring centrepiece which abuts the second hinge lever. The first hinge lever includes for each of the spring end pieces a holding element in which the associated spring end piece is engaged or can be engaged, and/or the second hinge lever includes a holding member in which the spring centrepiece is engaged or can be engaged.

The invention relates to a foldable-door hinge and a functional entity, in particular a piece of furniture or a room segment, comprising a foldable door, in particular a foldable sliding door, which is provided with at least one foldable-door hinge.

For closing off functional entities, such as openings of room segments or pieces of furniture, foldable doors, possibly foldable sliding doors, are often used which, after the opening has been released, are preferably moved into a door compartment or into a parking space so as not to appear disturbing.

A functional entity with a foldable sliding door is known, for example, from U.S. Pat. No. 8,336,972B2.

U.S. Pat. No. 9,284,761B2 discloses a piece of furniture with a displacement device by means of which a mounting profile connected to a foldable sliding door is displaceable within a door compartment. The foldable sliding door comprises two door elements, of which the first door element is connected at the rear by mounting hinges to a mounting profile and at the front by foldable-door hinges to the rear of a second door element, which is connected at the front to a guide carriage, which is displaceable along a guide rail, which comprises two rail sections aligned perpendicularly to one another and connected to one another by a curved section, of which a first rail section extends into the door compartment and a second rail section extends along the front of the piece of furniture. The mounting profile is held in vertical alignment by a supporting device and is provided on the upper side and the lower side with guide carriages that are displaceably supported in guide rails.

To close the piece of furniture, the foldable door is rolled out of the door compartment and unfolded. In the closed position, the door elements are aligned planar to each other. To open the piece of furniture, the foldable door is folded again, whereby the door elements are driven in an open position preferably aligned parallel to each other into the door compartment.

In the closed position, the foldable door must be kept in a planar orientation so that a folding process is not automatically initiated. After opening the foldable door from the closed position, it would be desirable if the folding process was carried out automatically.

DE202018100262U1 discloses a pressure-actuated holding device that assists in both holding the foldable door in the closed position and folding the foldable door after the foldable door is released from the closed position. This device comprises a first fitting member connected to the first door element of the foldable door and a second fitting member connected to the second door element of the foldable door. Between the first fitting member and a coupling device arranged on the second fitting member there is an ejector element which is movably connected to the first fitting member and the coupling device. An adjustment of the first fitting member relative to the coupling device takes place via a force accumulator which is to be loaded manually by the user and which acts against the ejector element. A release device is connected to the second door leaf via a connecting cable. The release of the locking device is affected by applying pressure to the planar aligned door elements, which pushes them further in the closing direction out of the planar alignment.

This device has a complex structure and requires numerous device parts, of which a first group is to be connected to the first door element and a second group to the second door element. Furthermore, device parts are provided which connect the two fitting members and thus the two door elements to each other and of which first device parts are mechanically guided, and second device parts are loosely held with corresponding effort, which is usually undesirable. Moreover, the door elements of the foldable door are held in the closed position solely by the holding device. Hence, measures are required to counteract accidental unlocking. Due to the use of two fitting parts, it must also be ensured that they are connected to the first and second door element at the correct distance from each other and in correct mutual alignment and height. It should also be noted that this device takes up a lot of space, which is disadvantageous given the limited space within the piece of furniture and especially within a door compartment.

U.S. Pat. No. 3,846,868A discloses a spring-loaded foldable-door hinge that allows hinged door elements to be rotated either to the open position or to the closed position after passing a central position. The foldable-door hinge is complex in design and requires fitting elements to be mounted on the upper edges of the door elements.

DE3104275A1 discloses foldable-door hinges provided with a drive spring, by which door elements hinged to each other can be automatically turned against one another. Disclosed are foldable-door hinges with hinge levers, which are connected to each other by spiral springs or leaf springs, for which a correspondingly large amount of space is required. When opening and/or closing the foldable-door hinge, the spiral spring is stretched, whereby no advantageous force curve can be realised. In particular, hinges equipped in this way with a drive spring only develop a desired rotational force over a very small range of rotation.

If the spiral spring should exert high forces, a correspondingly high spring constant is required. Coil springs with high spring constants usually require more space, which is why foldable-door hinges with larger dimensions result.

In addition, spiral springs with high spring constants are more difficult to assemble. If the spiral spring with a high spring constant is pre-assembled, the foldable door hinge can only be mounted on two door elements of the foldable door with great difficulty. The subsequent assembly of the spring with a high spring constant at the installation site, on the other hand, is hardly possible or only possible with the appropriate tools.

KR102137007B1 discloses a foldable-door hinge with two drive springs, each held in a cup and pierced by a hinge shaft, which comprises a reduced diameter in the area of the springs. This foldable-door hinge requires more effort to manufacture. The effect of the two springs, which each comprise only a few coils, is limited.

US721A is a foldable-door hinge with a first and a second plate-shaped hinge lever and with a drive spring comprising two spring packets which are connected to each other by a spring centrepiece and which each comprise a spring end piece on the sides facing away from each other. The spring end pieces abut the first hinge lever, and the spring centrepiece abuts the second hinge lever. After assembling this hinge, it is already ready for use, which is why its assembly on the door elements of a foldable door is difficult. Mounting the foldable-door hinge is particularly difficult if a particularly strong drive spring is used.

US721A discloses a foldable-door hinge with a first and a second plate-shaped hinge lever and with a drive spring which comprises two spring assemblies which are connected to one another by a spring centrepiece and which each comprise a spring end piece on the sides facing away from one another. The spring end pieces abut the first hinge lever, and the spring centrepiece abuts the second hinge lever. After assembling this foldable-door hinge, it is ready for use. As described above, the assembly of the ready-to-use foldable-door hinge on the door elements of a foldable door is difficult. It is particularly difficult to assemble the foldable-door hinge if a particularly strong drive spring is used.

The present invention is therefore based on the object of creating an improved foldable-door hinge which is equipped with a drive spring. Furthermore, a functional entity, in particular a piece of furniture, with a foldable door equipped with at least one such foldable-door hinge shall be created.

The inventive foldable door hinges shall easily be mountable on the door elements of a foldable door.

The foldable-door hinge, which comprises two hinge levers connected to each other by a drive spring, should take up little space, so that hardly any additional space is required compared to conventional hinges. The foldable-door hinge should therefore be visually imperceptible and optimally integrable into a door system.

Despite the small space requirement, the drive spring shall be able to exert high forces on the hinge levers. In particular, high forces shall be exerted over a high rotation range of the hinge levers.

The foldable-door hinge equipped with the drive spring shall be of simple design and its construction shall preferably differ only insignificantly from conventional hinges which comprise two hinge levers connected to each other by a hinge shaft. In particular, no or only very simple structural parts should be required to accommodate the drive spring.

The foldable-door hinge shall preferably operate without friction, so that no noise is caused, and no signs of wear occur even after long operation. Maintenance requirements shall be reduced to a minimum.

The use of the drive spring shall not interfere with the freedom of design of the other parts of the hinge, so that the foldable-door hinge equipped with the drive spring can still be designed as desired and is hardly limited to structural features that could interfere with the embodiment of the other hinge parts.

The drive spring should be easy to mount and connect to the hinge levers. In particular, a drive spring with a very high spring constant shall easily be mountable. The drive spring shall be mountable without the use of tools. In particular, the drive spring shall be mountable with minimal manual effort, preferably automatically.

By means of an inventive foldable-door hinge or by means of several inventive foldable-door hinges, a foldable door, which is held in a closed position by means of a holding device, for example, and is released from the closed position by manual action, should preferably be able to be folded automatically and completely.

A door gap between the door elements of the foldable door, which are connected to each other by foldable-door hinges, shall preferably be coverable with a bezel, which is correctly aligned after folding of the door elements and prevents manual intervention between the door elements and also realises a privacy screen, which gives the partially or fully folded foldable door an aesthetically advantageous appearance.

This task is solved with a foldable-door hinge according to claim 1 and a functional entity, possibly a piece of furniture or a room segment, with a foldable door according to claim 12, which is equipped with at least one such foldable-door hinge. Advantageous embodiments of the invention are defined in further claims.

The foldable-door hinge comprises
a first hinge lever, which comprises a first lever end piece with at least one bearing opening and a second lever end piece, which is connected or connectable to a first mounting part;
a second hinge lever, which comprises a first lever end piece with at least one bearing opening and a second lever end piece, which is connected or connectable to a second mounting part;
a hinge shaft which is held in the bearing openings of the hinge levers and which pivotably connects the two hinge levers to one another; and
a drive spring, which on the one hand abuts the first hinge lever and on the other hand abuts the second hinge lever.

The first lever end piece of the first hinge lever comprises two spaced apart first and second inner bearing arms with associated bearing openings between which the first end piece of the second bearing arm is held.

The first lever end piece of the first hinge lever further comprises two first and second outer bearing arms spaced apart from the inner bearing arms.

The drive spring comprises two spring packets, which enclose the hinge axis, and which are interconnected by a spring centrepiece, which abuts the second hinge lever

The first spring packet, which is arranged between the first inner bearing arm and the first outer bearing arm comprises, at an end remote from the spring centrepiece, a first spring end piece, which abuts the first outer bearing arm.

The second spring packet, which is arranged between the second inner bearing arm and the second outer bearing arm, comprises, at an end remote from the spring centrepiece, a second spring end piece, which abuts the second outer bearing arm.

According to the invention
the first hinge lever comprises for each of the spring end pieces a holding element in which the associated spring end piece is engaged or can be engaged, or
the second hinge lever comprises a holding member in which the spring centrepiece is engaged or can be engaged, or
the first hinge lever comprises for each of the spring end pieces a holding element in which the associated spring end piece is engaged or can be engaged, and that the second hinge lever comprises a holding member in which the spring centrepiece is engaged or can be engaged.

The inventive foldable-door hinge, which is equipped with a drive spring, can therefore be easily mounted on the door elements of a foldable door or foldable sliding door.

Preferably only after the foldable-door hinges have been mounted on the door elements of the foldable door or foldable sliding door, the drive spring is activated and engaged with the spring end pieces in the holding elements and/or the spring centrepiece in the holding member.

Preferably, it is provided,
that the holding elements are designed as latching elements into which the spring end pieces can engage, or
that the holding member is designed as a latching element into which the spring centrepiece can engage, or
that the holding elements are designed as latching elements into which the spring end pieces can engage, and that the holding member is designed as a latching element into which the spring centrepiece can engage.

By designing the holding elements and/or the holding member as latching elements, the spring end pieces can be advantageously connected to the holding elements and/or the spring centrepiece can be advantageously connected to the holding member. The following describes that the activation of the drive spring in a preferred embodiment can advantageously also take place by actuating the foldable door.

According to the invention, it is thus possible to integrate a strong drive spring with two spring packages advantageously into the foldable door hinge without causing difficulties during assembly. The two spring packets can exert high forces on the hinge lever, so that the foldable door is folded automatically after release from a closed position.

The spring packets of the drive spring preferably comprise helical or thread-like windings that are in contact with each other or are at least partially spaced from each other from winding to winding, so that the spring packets can be axially compressed.

Due to the helical embodiment of the drive spring, it can exert a high spring force on the hinge lever within a large rotation range of about 180°. If desired, the drive spring can also be provided with a pre-tension.

The helical embodiment of the drive spring allows a practically coaxial alignment of the spring packets in relation to the hinge shaft and thus the rotation axis of the foldable-door hinge. Hence, only little space is taken required. Even if the coils of the spring packets are provided with a larger diameter, the result is still a very slim structure of the foldable-door hinge.

The compressibility of the spring packets facilitates their coupling to the first hinge lever. By compressing the spring packets, the spring end pieces are axially displaced and can be guided more easily over a holding element provided on the first and second outer bearing arm by means of a tool or when operating the foldable-door hinge. A blockage can therefore be avoided.

In preferred embodiments of the foldable-door hinge, the drive spring coupled to the second hinge lever can be easily coupled to the first hinge lever by rotating the second hinge lever relative to the first hinge lever. A tool for coupling the drive spring with the hinge levers is therefore not required.

Preferably, the first and the second outer bearing arm each comprise a holding element which comprises a ramp or an inclined flank which preferably faces the second hinge lever and via which the associated first or second spring end piece can be inserted into a holding channel located behind the holding element, in which the associated first or second spring end piece is held after putting the foldable-door hinge into operation.

The drive spring can therefore be easily coupled to the first hinge lever by turning the second hinge lever with the drive spring against the first hinge lever. The spring end pieces, which are at the height of the holding elements, hit the ramp of the holding elements and are guided along them over the holding elements until they can fall into a holding channel behind the holding elements. This process can be easily carried out by mounting the hinges on the door elements and then folding the door elements until the spring end pieces are guided over the holding elements and engage in the corresponding holding channel.

The spring centrepiece is preferably held on the second hinge lever by a holding element when the second hinge lever is turned away from the first hinge lever and the drive spring is tensioned. For example, the holding element is hook-shaped or nose-shaped so that the spring centrepiece is reliably held.

In a preferred embodiment, the spring centrepiece is held on the second hinge lever between the holding element and a catch, which holds the spring centrepiece when the second hinge lever is rotated against the first hinge lever and the spring end pieces are coupled to the holding elements. A rest sink is thus formed between the holding element and the catch, in which the spring centrepiece is always securely held regardless of the direction of rotation of the second hinge lever.

The hinge shaft is held friction-free in the bearing openings of the hinge lever preferably by means of bearing elements made of plastic, for example a slidable thermoplastic such as POM. By avoiding contact between the metal hinge shaft and the metal hinge levers, unwanted friction and wear and tear as well as noise are avoided. The bearing elements preferably fulfil further functions. To secure the hinge shaft against axial displacement, it is preferably held pressed in one of the hinge arms. However, the axial displacement of the hinge shaft can also be prevented by means of at least one retaining ring.

Preferably, one bearing roller each is held by the hinge shaft inside the spring packets of the drive spring, the outer diameter of which is smaller than the inner diameter of the spring packets. The bearing rollers preferably comprise an axial bore, the inner diameter of which corresponds approximately to the outer diameter of the hinge shaft. The bearing rollers are therefore rotatably held by the hinge shaft with little play and can follow the movements of the spring packets and hold them in axial alignment. If the bearing rollers are held firmly, they still hold the spring packets in correct alignment due to their sliding ability. The spring packets are therefore always optimally aligned and cannot deform or jam. The movements of the spring packets are frictionless or largely frictionless without causing noise and/or wear.

The bearing openings of the first and second outer bearing arms preferably comprise an inner diameter that allows one bearing roller each to be pushed through and into the corresponding spring package. In this way the foldable-door hinge can easily be assembled.

Preferably, the bearing openings of the first and second outer bearing arms comprise an inner diameter that allows one of the bearing rollers to be pushed through and into the associated spring package and further into a bearing opening part of the adjacent first or second inner bearing arm. In this embodiment, the bearing rollers are held on both sides and form bearing elements for the hinge shaft. The hinge shaft can therefore hold the bearing rollers, or the bearing rollers can optimally hold the hinge shaft and the spring packets.

In a preferred embodiment, the hinge shaft extends beyond the first hinge lever on one side or on both sides, so that one end piece of the hinge shaft or both end pieces of the hinge shaft can be easily connected to a bezel device. If no bezel device is provided, an extension of the hinge shaft beyond the hinge lever is preferably omitted.

The bezel device preferably comprises a bezel profile having two profile side pieces that are connected to each other by a profile centrepiece. Within the bezel profile at least one holding module is form-fittingly, slidably, and lockably held, which comprises a connection element that is fixedly or releasably connected to the hinge shaft. The connection element is preferably a retaining clip that can be placed on the corresponding end piece of the hinge shaft and that snaps into place. After assembling the foldable door, the bezel profile can therefore easily be mounted by connecting the retaining modules to the foldable-door hinges.

The hinge arms of the foldable-door hinge are preferably designed in such a way that the bezel device is held in the closed position of the door elements behind the foldable door and after folding the door elements on the front side between the door elements. The door elements can be guided against each other on the front side without leaving a disturbing door gap. After opening the foldable door, on the other hand, it is ensured that the door gap is covered by means of the bezel profile and thus an aesthetically advantageous visual protection is realised, and the door gap cannot manually be interfered with.

Preferably, the first lever end piece of the first hinge lever is provided with at least one first stop element, and the first lever end piece of the second hinge lever is provided with at least one second stop element. The first and second stop elements are arranged on the first and second hinge lever in such a way that they are aligned in opposite directions after the rotation of the two hinge levers and form stop surfaces for the bezel profile. After opening the foldable door by means of the foldable-door hinge or the stop elements, the bezel profile is thus always held in a desired orientation in which the door gap is correctly covered.

An inventive functional entity, for example a piece of furniture, such as a wardrobe, or a room segment, is provided with at least one foldable door with two door elements which are connected to each other with one inventive foldable-door hinge or with several inventive foldable-door hinges.

The foldable-door hinges preferably hold a bezel device with a bezel profile, by means of which the door gap between the door elements is closed when they are folded against each other.

Preferably, the foldable door can be locked in a closed position and released from the closed position by means of a holding device. After releasing, the foldable door can automatically be transferred into a folded state by the foldable door hinge or the foldable door hinges.

In a preferred embodiment of the functional entity, the first door element is connected at an edge remote from the foldable-door hinges by mounting hinges to a mounting profile which is displaceable within a door compartment of the functional entity.

It is further preferred that the second door element is connected at an edge remote from the foldable-door hinges to a guide carriage which is guided in a guide rail running along the front side of the functional entity.

The invention is explained in more detail below with reference to the drawings. Thereby shows:

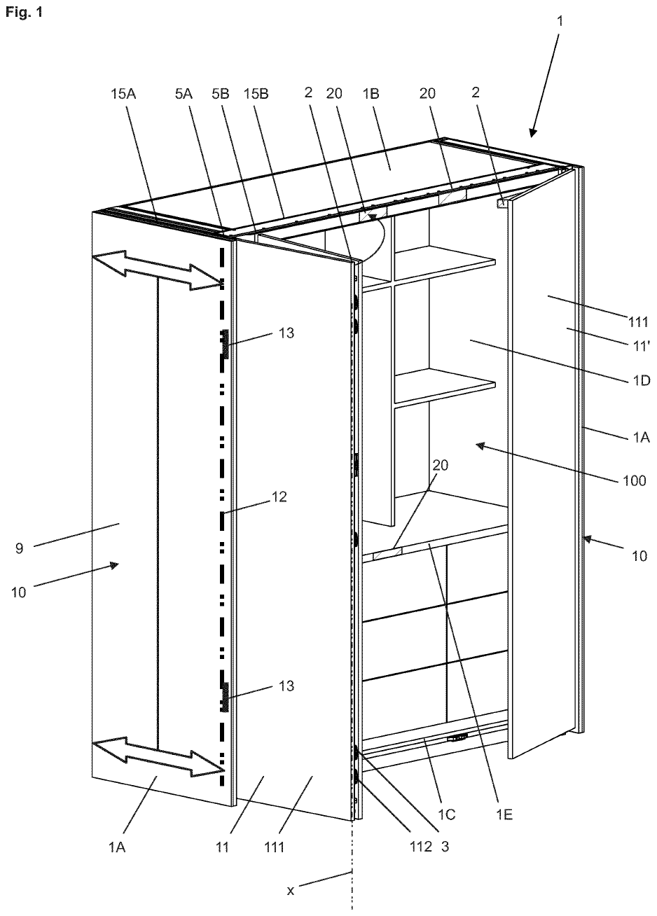

FIG. 1 an inventive functional entity 1 in the embodiment of a piece of furniture with a foldable door 11 with two door elements 111, 112, which are connected to each other by an inventive foldable-door hinge 3 or by several inventive foldable-door hinges 3 and are insertable folded into a first door compartment 10, and with a door 11′ with only one door element 111, which is insertable into a second door compartment 10;

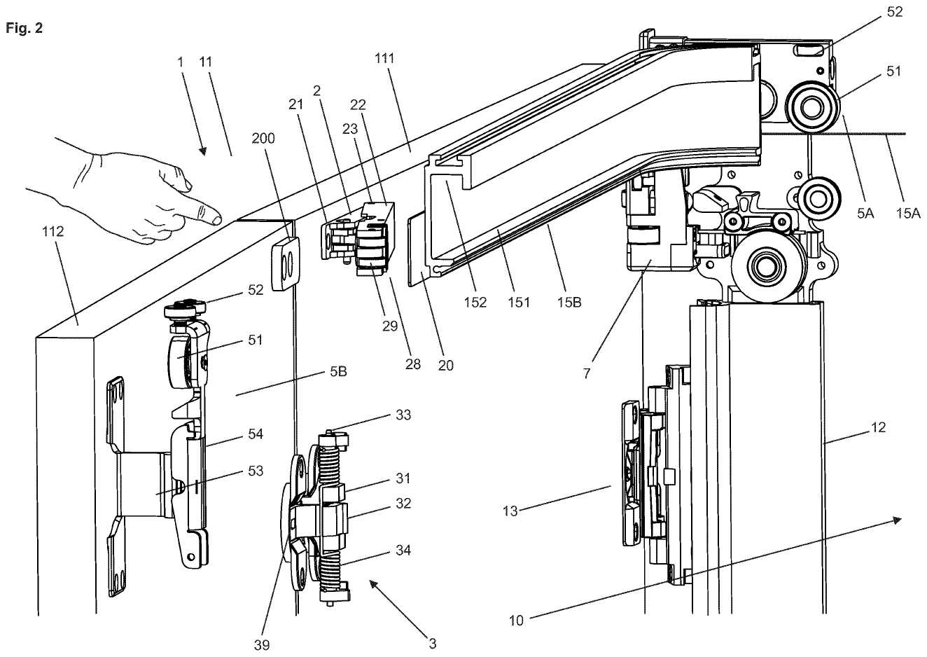

FIG. 2 the rear side of the foldable door 11 of the piece of furniture 1 of FIG. 1 with the first door element 111, which is connected at the trailing edge by mounting hinges 13 to a mounting profile 12 and at the leading edge by one or more inventive foldable-door hinges 3 to a second door element 112, and on which in this preferred embodiment a holding device 2 is mounted, which comprises a holding magnet 28, which in the closed position of the foldable door 11 cooperates with a magnetic or ferro-magnetic locking element 20, which is held stationary by a part of the piece of furniture 1;

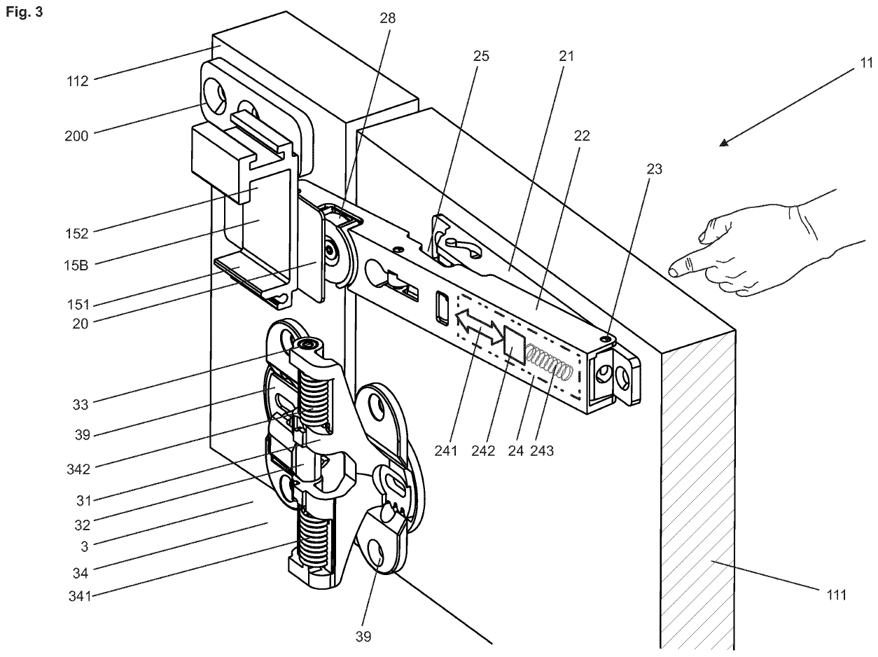

FIG. 3 a part of the foldable door 11 of FIG. 2 shortly before reaching the closed position or shortly after being released from the closed position, with the foldable door hinge 3, which comprises two hinge levers 31, 32, which on the one hand are connected by mounting parts 39 to the associated door element 111; 112 and on the other hand are connected to one another by a hinge shaft 33 and cooperate with parts of a drive spring 34, from which opposing torques are exerted on the hinge levers 31, 32;

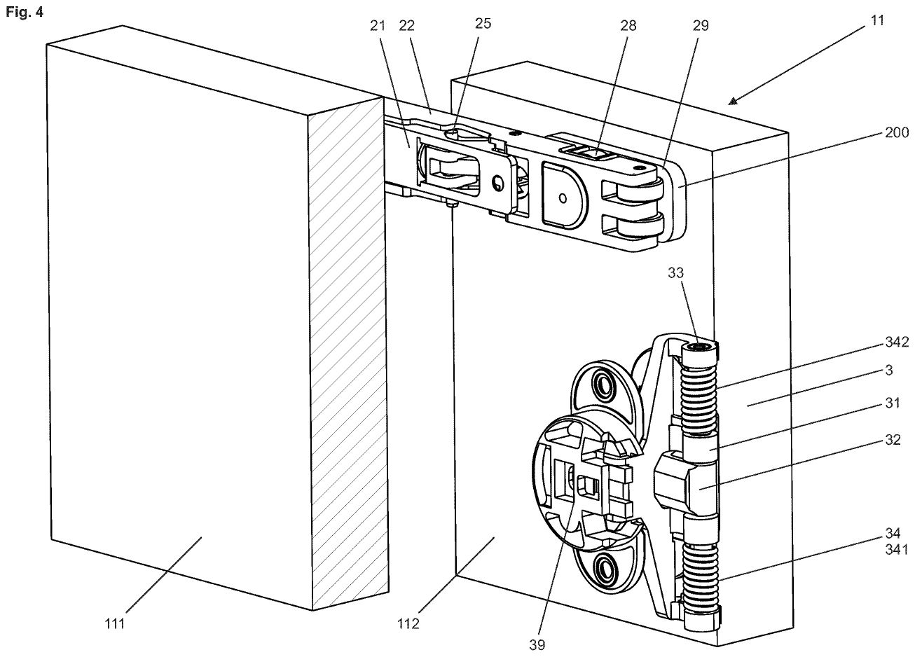

FIG. 4 the foldable door 11 of FIG. 3 with the first door element 111 in sectional view and the second door element 112 in parallel alignment thereto, in which the foldable door 11 can be inserted into a door compartment 10 and in which the hinge levers 31, 32 of the foldable-door hinge 3 are turned against one another and the drive spring 34 is fully or partially de-energised;

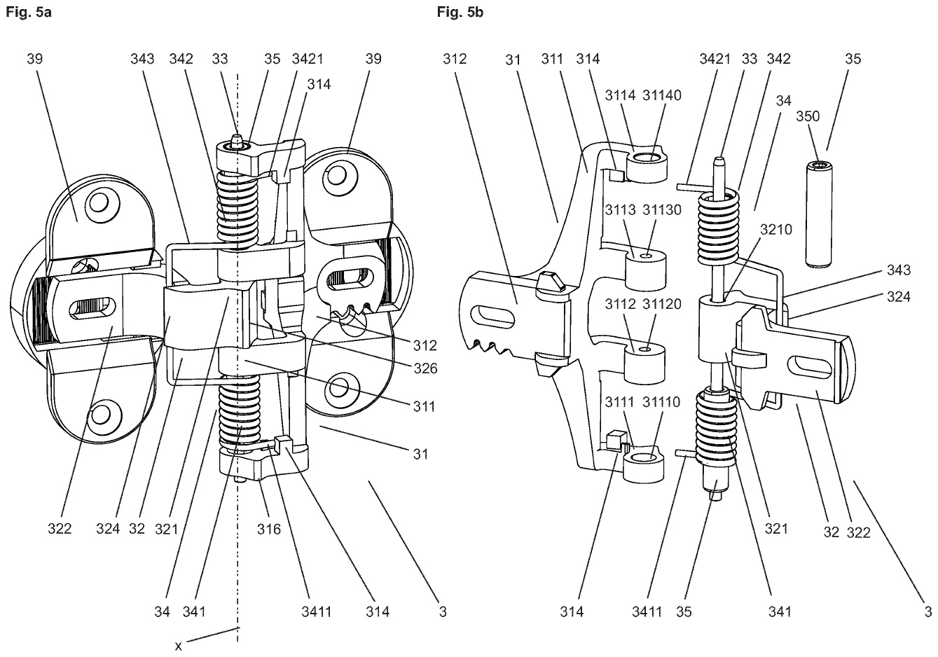

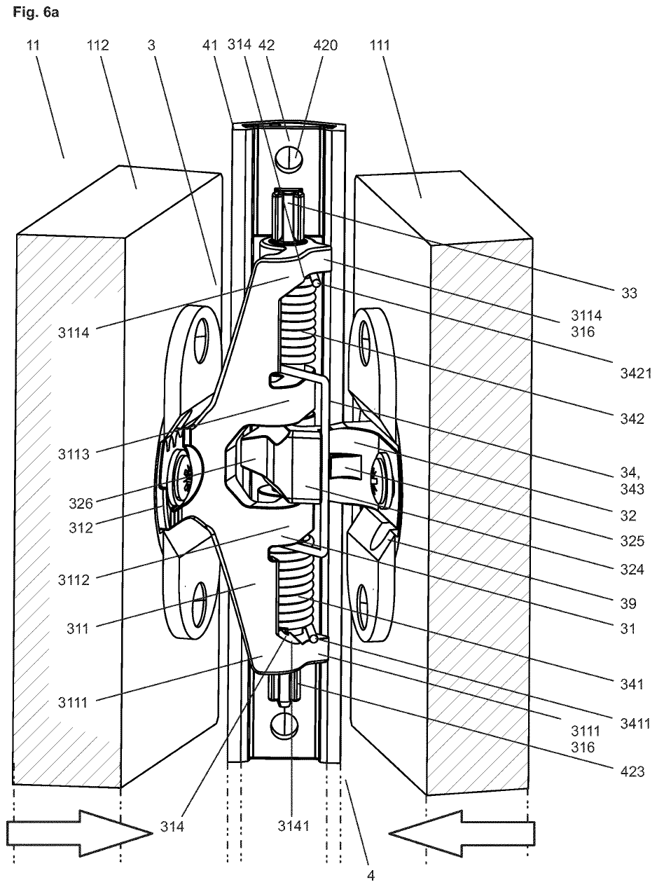

FIG. 5a the foldable-door hinge 3 of FIG. 2 connected with two mounting parts in the embodiment of hinge pots 39 with the drive spring 34 comprising two helical spring packets 341, 342 enclosing the hinge shaft 33 and abutting the first hinge lever 31 with spring end pieces 3411, 3421 and being interconnected by a spring centrepiece 343 engaged in a holding member 324 of the second hinge lever 32;

FIG. 5b the foldable-door hinge 3 of FIG. 5a without the hinge cups 39 in exploded view;

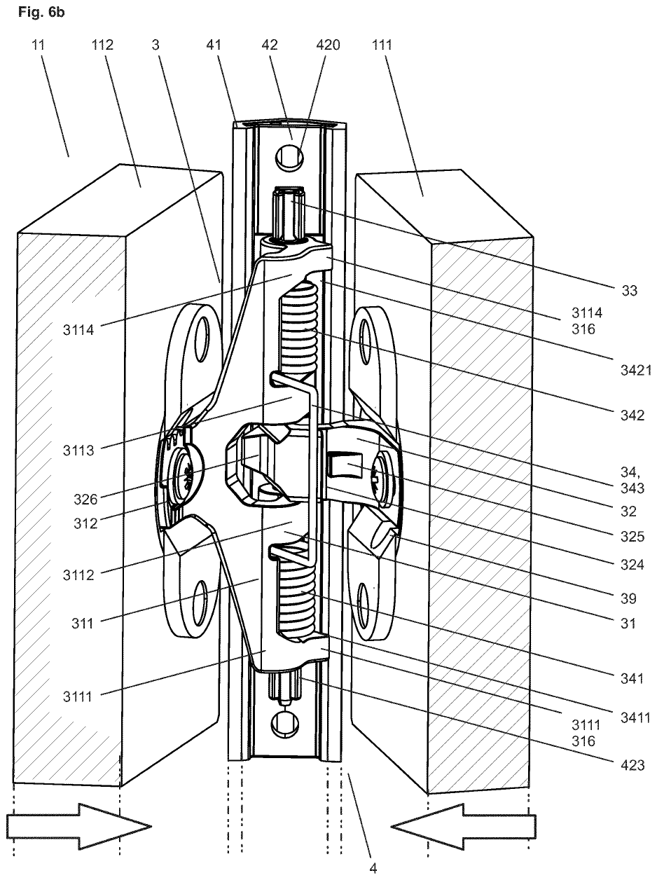

FIG. 6a the foldable-door hinge 3 of FIG. 2 in a preferred embodiment with the drive spring 34 of FIG. 5b, whose spring centrepiece 343 is engaged in the holding member 324 of the second hinge lever 32, but whose spring end pieces 3411, 3421 are not yet coupled to the first hinge lever 31, and with a bezel device 4 held by the hinge shaft 33;

FIG. 6b the foldable-door hinge 3 of FIG. 6a in a preferred embodiment with the drive spring 34, whose spring end pieces 3411, 3421 are coupled to the first hinge lever 31, but whose spring centrepiece 343 is not yet engaged in the holding member 324 of the second hinge lever 32;

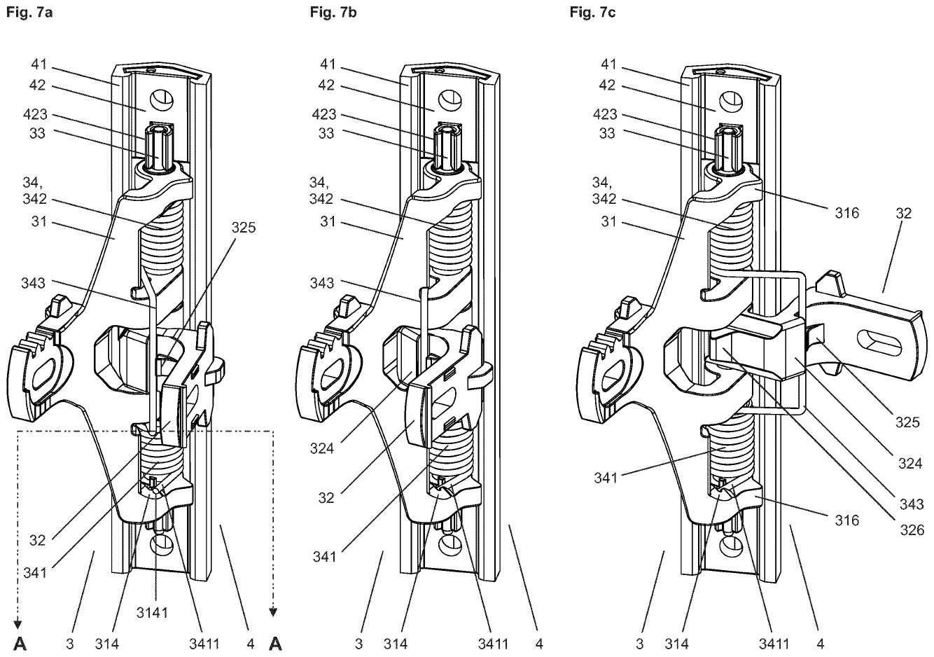

FIG. 7a the foldable-door hinge 3 of FIG. 6a of the drive spring 34 during the process of coupling the spring end pieces 3411, 3421 to the first hinge lever 31, in which the second hinge lever 32 is rotated against the first hinge lever 31 or the first and second hinge levers 31, 32 are rotated against each other;

FIG. 7b the foldable-door hinge 3 of FIG. 7a after completion of the process of coupling the spring end pieces 3411, 3421 to the first hinge lever 31;

FIG. 7c the foldable-door hinge 3 of FIG. 7b with the drive spring 34 coupled to the first and second hinge lever 31, 32 and partially tensioned after a counterclockwise rotation of the second hinge lever 32;

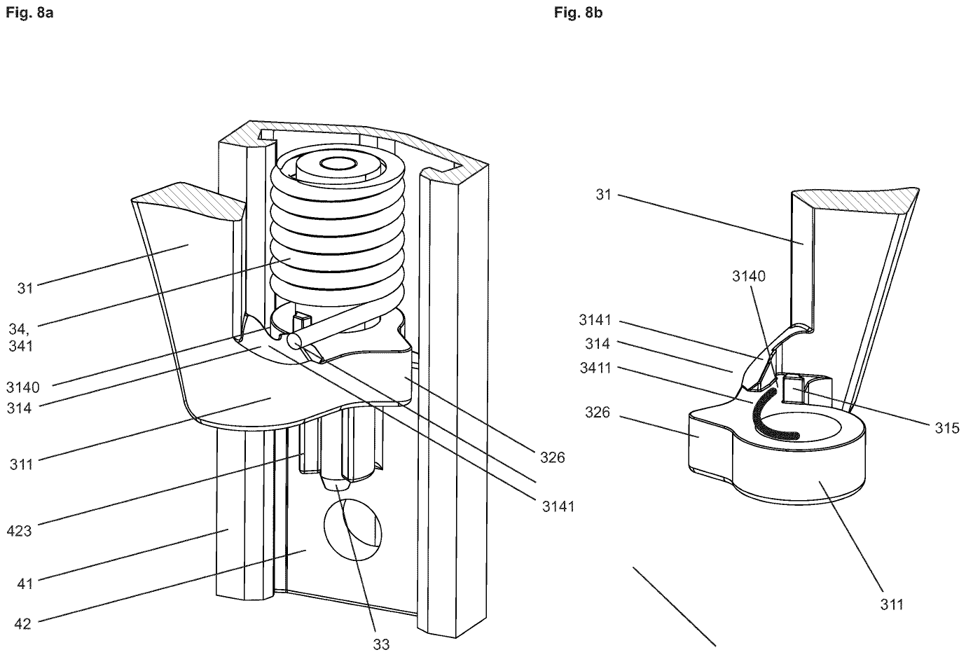

FIG. 8a a section along line A-A through the foldable-door hinge 3 of FIG. 7a with the first spring end piece 3411 of the drive spring 34, which is guided over a ramp 3141 of a holding element 314 on the first lever end piece 311 of the first hinge lever 31 during a clockwise rotation of the second hinge lever 32 until it engages behind the holding element 314 in a holding channel 3140;

FIG. 8b the first lever end piece 311 of the first hinge lever 31 of FIG. 8a with the holding element 314, which comprises an inclined flank or ramp 3141 and which adjoins the holding channel 3140, which is delimited on one side by the holding element 314 and on the other side by a preferably provided holding cam 315 and in which the spring end piece 3411 is held;

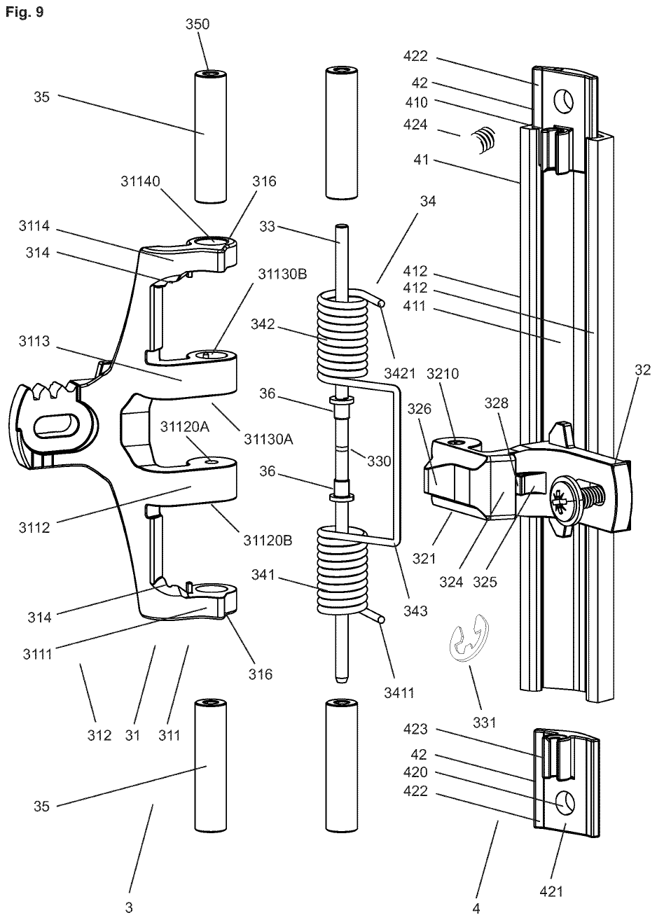

FIG. 9 the foldable-door hinge 3 and the bezel device 4 of FIG. 6a or FIG. 6b in exploded view;

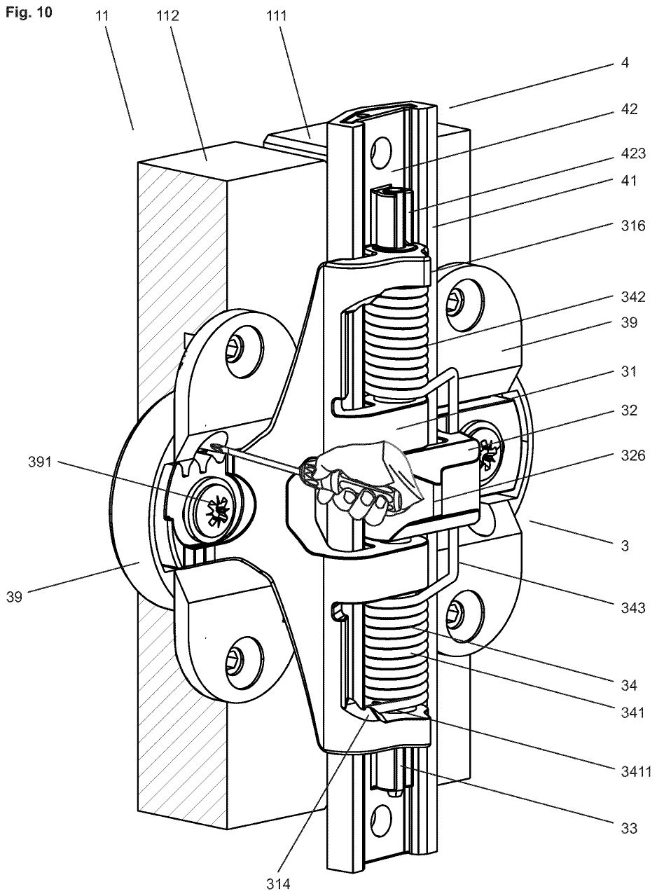

FIG. 10 the foldable-door hinge 3 and the bezel device 4 of FIG. 6a or FIG. 6b in the closed position of the foldable door 11;

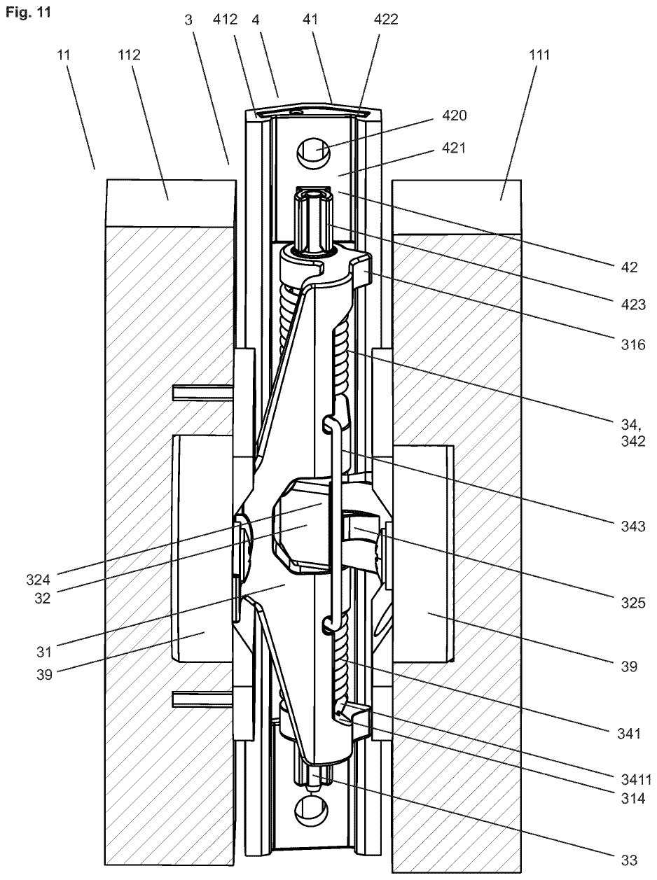

FIG. 11 the foldable-door hinge 3 and the bezel device 4 of FIG. 10 with the door elements 111, 112 folded against each other, between which the bezel device 4 of the foldable-door hinge 3 is held in precise alignment; and

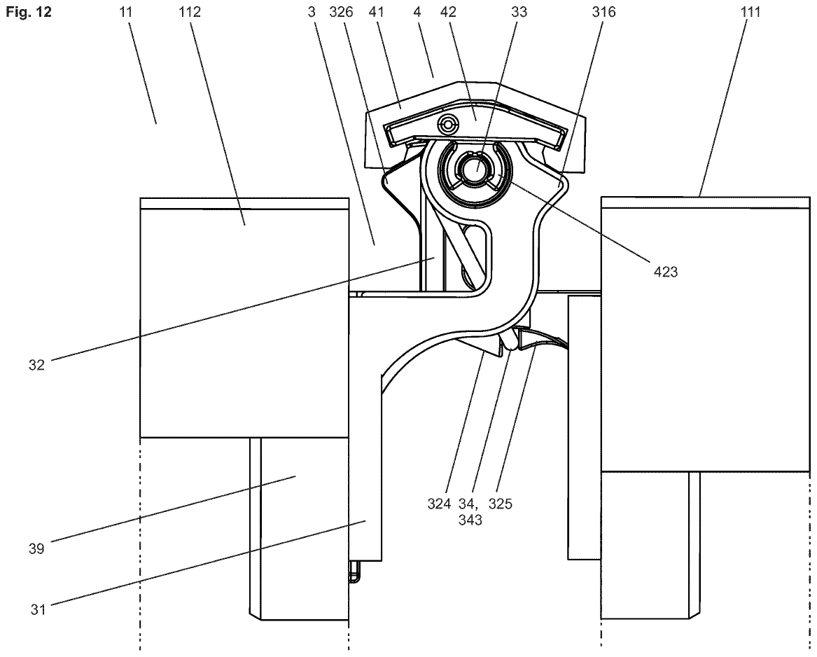

FIG. 12 the foldable-door hinge 3 and the bezel device 4 of FIG. 11 viewed from above.

FIG. 1 shows an inventive functional entity 1 in the embodiment of a piece of furniture 1 with a foldable door 11, which can be inserted into a first door compartment 10, and with a one-part door 11′, which can be inserted into a second door compartment 10. The foldable door 11 and the one-part door 11′ are preferably each provided with a holding device 2 by means of which they can be held in the closed position. Any holding device 2 can be used. Particularly advantageous is the use of a holding device 2 as described below.

The piece of furniture 1 preferably comprises side walls 1A, an upper board 1B, a lower board 1C, an intermediate wall 1E and partition walls 1D on both sides, which together with the side walls 1A delimit the door compartments 10.

The foldable door 11 comprises a first door element 111, which is connected on one side by mounting hinges 13 to a mounting profile 12, and on the other side by inventive foldable-door hinges 3 to a second door element 112, the dimensions of which preferably correspond to the dimensions of the first door element 111. The foldable door 11 is slightly unfolded and can either be fully folded and retracted into the door compartment 10 with the door elements 111, 112 aligned parallel to each other or fully unfolded and transferred into a closed position in which the two door elements 111, 112 are at least approximately aligned in one plane. In order to hold the foldable door 11 in the closed position and to be able to release it from the closed position in a simple manner, one of the two door elements 111, 112, preferably the first door element 111, is provided with a holding device 2, which in the closed position is opposite a locking element 20. It is symbolised by an arrow that the holding device 2 of the foldable door 11, which is provided with a magnetic element, is guided against the locking element 20 during a rotation of the first door element 111 and is magnetically held by the locking element 20 in the closed position.

In the embodiment shown in FIG. 1, the doors 11, 11′ are each connected by mounting hinges 13 to a mounting profile 12 which is held in vertical alignment by a displacement device 9 and is displaceable within the associated door compartment 10. The doors 11 are aligned parallel to the side wall 1A in front of the associated door compartment 10 and can subsequently be displaced into the door compartment 10. For the displacement within the door compartment 10, the mounting profile 12 can also be provided with drive devices. Preferably, the mounting profile 12 is connected at the upper side to a support carriage 5A, which is displaceable along an associated support rail 15A into the door compartment 10. On the underside, the mounting profile 12 can also be connected to a carriage that is guided in a support rail.

In this preferred embodiment, the leading edge of the second door element 112 of the foldable door 11 is connected to a guide carriages 5B which is guided in a guide rail 15B extending along the front side of the piece of furniture 1 and along a curve into the door compartment 10. The foldable door 11 is therefore held at the front side by means of the guide carriage 5B, which in the unfolded state of the foldable door 11 is displaceable along the front side of the piece of furniture 1 and in the folded state of the foldable door 11 is displaceable into the door compartment 10. The guide carriage 5B always runs ahead of the second door element 112 in the direction of movement. By using the guide carriage 5B, the foldable door 11 can be unfolded and folded with little effort.

FIG. 2 shows the rear side of the foldable door 11 of the piece of furniture 1 of FIG. 1 with the first door element 111, which is connected at the trailing edge by the mounting hinges 13 to the mounting profile 12 and at the leading edge by inventive foldable-door hinges 3 to the second door element 112, at the front side of which the guide carriage 5B is mounted. The guide carriage 5B comprises support rollers 51 which can roll on a support element 151 of the guide rail 15B, and guide rollers 52 which are guided in a guide channel 152 of the guide rail 15B. It is shown that the guide rail 15B extends along the front side of the piece of furniture 1 and around a curve into the door compartment 10 of the piece of furniture 1. For the guide carriage 5B to follow this curve, it is connected to the second door element 112 by parts 53, 54 of a drive body which are pivotally connected to each other.

The mounting profile 12 is connected at the upper end to a support carriage 5A, which can be moved along a support rail 15A into the door compartment 10. In FIG. 2, the support carriage 5A is guided up to a stop device 7 at the front of the door compartment 10. In this position, which is also shown in FIG. 1, the foldable door 11 is fully extended from the door compartment 10 and can be unfolded to close the furniture opening 100 (see FIG. 1). In FIG. 2, the foldable door 11 has almost reached the closed position and can be brought into the closed position by manual pressure on the foldable door 11, preferably on the leading edge 111, in which the holding device 2 mounted on the rear side of the separating element 111 can magnetically interact with the locking element 20 connected to the front side of the guide rail 15B.

The holding device 2 comprises a mounting part 21, which is preferably connected to the first door element 111 by means of screws and to a holding lever 22 by means of a lever shaft 23. At the front-end piece or the holding lever 22 is provided with a holding magnet 28 and preferably with one or more spacer rollers 29.

The spacer rollers 29 can roll on the locking element 20 and/or the guide rail 15B during the closing process without the holding lever 22 touching the locking element 20 or the guide rail 15B. The holding lever 22 is rotated and the holding magnet 28 is aligned almost frontally against the locking element 20 so that it can magnetically couple to the magnetic or ferro-magnetic locking element 20 in the closed position of the foldable door 11.

After being released from the closed position, the two door elements 111, 112 are preferably folded automatically. This folding process is carried out automatically or at least supported by inventive foldable-door hinges 3, which connect the two door elements 111, 112 with each other.

The foldable-door hinge 3 comprises two hinge levers 31, 32, which are connected at the ends facing away from each other by mounting parts, preferably hinge cups 39, each to the associated door element 111, 112 and which are connected to one another at the lever end pieces facing each other by a hinge shaft 33. Furthermore, a drive spring 34 is provided, which acts with spring end pieces on the first hinge lever 31 and with a spring centrepiece on the second hinge lever 32, as described below. The drive spring 34 thus acts on the two hinge levers 31, 32 and tries to turn them against each other and to fold the door elements 111, 112.

FIG. 2 also shows a spacer plate 200 which has no function in the closed position of the foldable door 11. In the folded position of the foldable door 11 with parallel alignment of the door elements 111, 112, the front piece of the holding lever 22 with the spacer rollers 29, however, abuts the spacer plate 200 and is pressed against the mounting part 21 and preferably aligned parallel thereto, so that it takes up as little space as possible when pushed into the door compartment 10 (see FIG. 4).

FIG. 3 shows a part of the foldable door 11 of FIG. 2 shortly before it reaches the closed position or shortly after it is released from the closed position. The door elements 111, 112 of the foldable door 11 are not yet aligned in a plane and the holding magnet 28 is not yet in contact with the locking element 20. The holding lever 22 is inclined with respect to the mounting part 21 and faces the locking element 20 and will contact it with the spacer rollers 29 first. The spacer rollers 29, preferably made of plastic, will hardly make any noise.

The holding magnet 28 is recessed into a magnetic chamber and is thus partially enclosed by a magnetic cup which protrudes from the front, for example by 0.2 mm-2 mm, so that the holding magnet 28 cannot strike the locking element 20.

A hand symbolises that the holding device 2 can be locked in the closed position of the foldable door 11 by a first manual pressure and can be released again by a second manual pressure.

For locking the holding device 2, the holding device 2 comprises a locking unit 24 with a force transmitter 241, which is cyclically displaceable in the locking unit 24 by the action of pressure between a locking position, in which the holding device 2 reaches a holding position, and a release position, in which the holding device 2 reaches a release position.

The locking unit 24 with the force transmitter 241 is shown schematically. The force transmitter 241, which is supported by a positioning spring 243, can be moved axially and actuates a switching mechanism 242 in which a latching element is moved cyclically between a latching position and a release position.

The foldable-door hinge 3 comprises a drive spring 34 which is tensioned in this position of the foldable door 11 and tries to fold the door elements 111, 112 against each other against the force of the user. The holding device 2 must therefore be magnetically coupled with the locking element 20 in the closed position and locked by means of the locking unit 24 so that the foldable door 11 is held in the closed position. The drive spring 34 is therefore loaded by manual force and subsequently serves to fold the foldable door 11 automatically as soon as it is released from the closed position.

FIG. 4 shows the foldable door 11 of FIG. 3 with the first door element 111 in sectional view and the second door element 112 in parallel alignment thereto, in which the foldable door 11 can be inserted into the associated door compartment 10. The front part of the holding lever 22 lies with the spacer rollers 229 against the spacer plate 200 and holds the holding lever 22 at least approximately parallel to the mounting part 21.

The hinge levers 31, 32 of the foldable-door hinge 3 connected by the hinge shaft 33 have been turned against each other. The hinge spring 34 is therefore fully or partly de-energised.

FIG. 5a shows the foldable-door hinge 3 of FIG. 2 comprising a first hinge lever 31 and a second hinge lever 32 connected by a hinge shaft 33. Further, the foldable-door hinge 3 comprises a drive spring 34 having two spring packs 341, 342 which are connected to each other by a spring centrepiece 343 and which have spring end pieces 3411, 3421 provided thereon. The drive spring 34 is tensioned in this position of the foldable-door hinge 3 and encloses the hinge shaft 33 with the spring packets 341, 342. Furthermore, the drive spring 34 rests with the spring end pieces 3411, 3421 on the first hinge lever 31 and with the spring centrepiece 343 on the second hinge lever 32.

The first hinge lever 31 comprises a first lever end piece 311 having four bearing arms 3111, 3112, 3113, 3114 (see FIG. 5b), two outer bearing arms 3111, 3114 and two inner bearing arms 3112, 3113 through which the hinge shaft 33 passes, and a second lever end piece 312 connected to an associated mounting element or hinge cup 39.

The second hinge lever 32 comprises a first lever end piece 321 held between the two inner bearing arms 3112, 3113 of the first hinge lever 31 and penetrated by the bearing shaft 33, and a second lever end piece 322 connected to an associated mounting element or hinge cup 39.

On the outer bearing arms 3111, 3114 holding elements 314 are provided, in which the spring end pieces 3411, 3421 of the spring packets 341, 342 are engaged and held. The second bearing arm 32 comprises a holding member 324 in which the spring centrepiece 343 is suspended and held. The spring packets 341, 342 attempt to turn the first hinge lever 31, which is held by the spring end pieces 3411, 3421, in a clockwise direction and the second hinge lever 32, in which the spring centrepiece 343 is engaged, in a counterclockwise direction about the hinge axis, which defines an axis of rotation x.

Within each of the spring packets 341, 342 a preferably sleeve-shaped bearing roller 35 with an axial bore 350 is held, which is penetrated by the hinge shaft 33. Movements of the spring packets 341, 342 are therefore absorbed by the bearing rollers 35, which is why the spring packets 341, 342 are always held in axial alignment and undesirable deformations of the spring packets 341, 342 and friction of the spring packets 341, 342, for example on the hinge shaft 33, are avoided.

The diameter of the bearing rollers 35 is preferably chosen in such a way that there is always a clearance between the bearing rollers 35 and the spring assemblies 341, 342, even if their inner diameter changes during actuation of the foldable-door hinge 3.

Mounting elements, e.g., hinge cups 39, can be connected to the associated lever end pieces 312, 322 in a force-fitting and/or form-fittingly manner. As shown, the mounting elements 39 are preferably movable or adjustable relative to the lever end pieces 312, 322 and can be fixed in a suitable position.

FIG. 5b shows an exploded view of the foldable-door hinge 3 of FIG. 5a in a preferred embodiment. It is shown that in this embodiment the inner bearing arms 3112 and 3113 comprise smaller bearing openings 31120, 31130, which can only accommodate the hinge shaft 33, but not the bearing rollers 35. The bearing rollers 35 each comprise an axial bore 350, in which the hinge shaft 33 is preferably held rotatably but largely without play. The outer bearing arms 3111 and 3114, on the other hand, comprise larger bearing openings 31110, 31140 into which the bearing rollers 35 can be inserted. The first end piece 321 of the second hinge lever 32 is also provided with a bearing opening 3210, into which the hinge shaft 33 is already inserted.

The foldable-door hinge 3 can therefore be easily assembled by inserting the first lever end piece 321 of the second hinge lever 32 between the two inner bearing arms 3112, 3113 of the first hinge lever 31 and the spring packets 341, 342 of the drive spring 34 between an outer and an inner bearing arm 3111, 3112 and 3114, 3113 respectively. Then the bearing rollers 35 are inserted through the bearing holes 31110, 31140 of the outer bearing arms 3111, 3114 and into the corresponding spring packet 341 or 342. Finally, the hinge shaft 33 is passed through the lever end pieces 311, 321, the bearing rollers 35 and the spring packets 341, 342. Preferably, in one of these steps, the spring centrepiece 343 is engaged in the holding element 324 of the second hinge lever 32. In addition, the spring end pieces 3411, 3421 are engaged in the holding elements 314 on the outer bearing arms 3111, 3114. Optionally, mounting elements 39 are connected to the hinge levers 31, 32.

As a result, the foldable-door hinge 3 has the configuration shown in FIG. 5a, in which the spring end pieces 3411, 3421 are engaged in the holding elements 314 on the outer bearing arms 3111, 3114. In FIG. 5a, the holding elements 314 are cuboid-shaped, which is why the spring end pieces 3411, 3421 must be lifted over the holding elements 314 with a tool. In the preferred embodiments of the foldable-door hinge 3 described below, this process is substantially simplified by a preferred embodiment of the holding elements 314, so that the coupling process can be carried out practically automatically.

In all embodiments of the foldable-door hinge 3, the drive spring 34 takes up hardly any space and yet develops a very high spring force, so that the door elements 111, 112 can be turned forcefully from the closed position, in which they are aligned in one plane, preferably to the folded position, in which they are aligned parallel to each other. In the folded position, the force exerted by the drive spring 34 is reduced to a minimum. In addition, the movement of the door elements 111, 112 in this area is preferably damped by means of a damping element or a damping device, so that no impact noise is generated.

The spring packets 341, 342 supported by the bearing rollers 35 remain coaxially aligned with the hinge shaft 33 during this rotation process and can operate without friction. It is particularly advantageous that the spring packets 341, 342 do not have to be arranged and held inside a hinge housing, but can be arranged exposed, which results in a simple construction with minimal space requirements. The drive spring 34 is therefore almost completely integrated into the foldable-door hinge 3, resulting in an optically and functionally optimal solution.

The drive spring 34 can follow the movements of the hinge arms 31, 32 without friction with the two spring packets 341, 342, which exert high forces on the hinge arms 31, 32. It is particularly advantageous that a powerful drive spring 34 can be integrated into the foldable door hinge 3 without taking up significantly more space.

FIG. 6a shows the foldable-door hinge 3 of FIG. 2 in a preferred embodiment with the drive spring 34 of FIG. 5b, whose spring centrepiece 343 is engaged in the holding member 324 of the second hinge lever 32, but whose spring end pieces 3411, 3421 are not yet coupled to the first hinge lever 31. In this configuration of the foldable-door hinge 3, in which the drive spring 34 is not yet coupled to the first hinge lever 31, the foldable-door hinge 3 comprises only a hinge function, but not a drive function. Hence, in this state, the foldable-door hinge 3 can conveniently mounted on the door elements 111, 112.

To engage the spring end pieces 3411, 3421 in the holding elements 314, however, no tools are required. Instead, the door elements 111, 112 are moved against each other with minimal force, which is symbolised by two arrows. When the first door element 111 and thus the second hinge lever 32 are rotated clockwise, the spring centrepiece 343 is carried along and the drive spring 34 is rotated clockwise around the hinge shaft 33. The spring end pieces 3411, 3421 are guided against the holding elements 314, which are now no longer cuboid-shaped, but comprise a ramp or an inclined flank 3141 on the side facing the spring end pieces 3411, 3421. In FIG. 6a, the spring end piece 3411 is still in front of the ramp 3141, which is stepless so that the spring end piece 3411 can slide over it during a rotation. With a further rotation of the drive spring 34, the spring end pieces 3411, 3421 are guided over the ramp or the inclined flank 3141 until they have overcome the holding elements 314 and can each enter a holding channel 3140 in which they are firmly held.

Preferably, the coils of the spring packets 341, 342 are spaced apart so that the spring packets 341, 342 can be compressed during the process of coupling the spring end pieces 3411, 3421 and the spring end pieces 3411, 3421 can thereby more easily traverse the ramps 3141 of the holding elements 314.

For the second hinge lever 32 to be able to carry the spring centrepiece 343 along during a clockwise rotation, the hinge lever 32 is preferably provided with a catch 325, which is opposite the holding member 324. The spring centrepiece 343 is therefore held in a rest sink 328 (see FIG. 9) between the holding member 324 and the preferably provided catch 325. During a clockwise rotation of the second hinge lever 32, in which the spring end pieces 3411, 3421 are coupled to the first hinge lever, the spring centrepiece 343 is in contact with the catch 325, and during a subsequent counterclockwise rotation of the second hinge lever 32, in which the drive spring 34 is tensioned, the spring centrepiece 343 is in contact with the holding member 324.

FIG. 6a further shows a bezel device 4 with a bezel profile 41, in which a holding module 42 is held form-fittingly, but axially displaceable and fixable. To fix the holding modules 42, they comprise a threaded bore 420 into which a threaded bolt can be screwed up to the bezel profile 41 and braced with it. For the connection with the foldable-door hinge 3, the holding modules 42 comprise a connection element preferably in the embodiment of a retaining clip 423, which can be coupled with the hinge shaft 33, which projects beyond the first hinge lever 31 on both sides and is thus led out of the foldable-door hinge 3 on both sides. The bezel device 4 can therefore be easily coupled to the foldable door 11 or to the foldable-door hinges 3 in order to cover or close the opening between the two door elements 111, 112 when they are folded against each other. On the one hand, this covers the aesthetically disturbing door gap. On the other hand, it prevents manual intervention in the door gap and injuries from occurring when operating the folding door 11.

FIG. 6a further shows an optional function of the two hinge levers 31, 32 to keep the bezel device 4 or the bezel profile 41 in a desired orientation within the opened door gap between the first and the second door element 111, 112. For this purpose, the first lever end piece 311 of the first hinge lever 31 facing the hinge shaft 33 comprises a first stop element 316 on at least one of the outer lever arms 3111, 3114 and the first lever end piece 321 of the second hinge lever 32 facing the hinge shaft 33 comprises a second stop element 326. When the two hinge levers 31, 32 are rotated towards each other, the first stop elements 316 of the first hinge lever 31 and the second stop element 326 of the second hinge lever 32 are each guided forward to one side of the bezel profile 41, which is thereby automatically aligned parallel to the front side of the functional entity 1. This ensures that the bezel device 4 or the bezel profile 41 can actually perform its intended function and cover the door gap between the folded door elements 111, 112.

The process of coupling the spring end pieces 3411, 3421 to the first hinge lever 31 is illustrated in FIGS. 7a, 7b and 7c looking at the first spring end piece 3411. The coupling of the second spring end piece 3421 takes place simultaneously in the same way.

FIG. 6b shows the foldable-door hinge 3 of FIG. 6a in a preferred embodiment with the drive spring 34, whose spring end pieces 3411, 3421 are coupled to the first hinge lever 31, but whose spring centrepiece 343 is not yet engaged in the holding member 324 of the second hinge lever 32. In this embodiment, the spring end pieces 3411, 3421 are therefore preferably already coupled to a holding element 314 of the first hinge lever 31, while the second hinge lever 32 is not yet coupled to the drive spring 34 or to the spring centrepiece 343 before the first operation of the foldable-door hinge 3. Hence, in this state, the foldable-door hinge 3 can conveniently mounted on the door elements 111, 112.

The holding member 324 is preferably designed as a latching element so that the spring centrepiece 343 can slide over the holding member 324 and engage behind it when the hinge arms 31, 32 are turned together. For example, the holding member 324 is nose-shaped, hook-shaped, or sawtooth-shaped.

To couple the drive spring 34 or spring centrepiece 343 to the second hinge lever 32, the two hinge levers 31, 32 or the door elements 111, 112 are again turned against each other. During this process, the spring centrepiece 343 is guided over the holding member 324 and due to its elasticity possibly slightly bent until it can engage behind the holding member 324.

Preferably, the embodiments of the foldable-door hinge 3 of FIG. 6a and FIG. 6b are combined so that the spring end pieces 3411, 3421 can be automatically coupled to the preferably ramp-shaped holding elements 314 and the spring centrepiece 343 of the drive spring 34 can be automatically coupled to the holding member 324 when the two hinge levers 31, 32 are first rotated towards each other.

In FIG. 7a, the second hinge lever 32 has been turned slightly clockwise compared to the position in FIG. 6a. In this operation, as the catch 325 rotates the spring centrepiece 343 clockwise, the spring end piece(s) 3411, 3421 have been guided onto the ramp 3141 of the associated holding element 314 and may have been slightly bent and/or lifted by compression of the spring packet 341.

In FIG. 7b, the spring end piece(s) 3411, 3421 have overcome the ramp 3141 and are engaged behind the holding elements 314.

In FIG. 7c, the spring end pieces 3411, 3421 are held by the holding elements 314 while the second hinge lever 32 was turned back in a counterclockwise direction. During this process, the spring centrepiece 343 was driven counterclockwise by the holding member 324 of the second hinge lever 32 and the drive spring 34 was partially tensioned.

FIG. 8a shows a section along line A-A through the foldable-door hinge 3 of FIG. 7a with the first spring end piece 3411 of the drive spring 34, which is guided over the ramp 3141 of a holding element 314 on the first lever end piece 311 of the first hinge lever 31 during clockwise rotation of the second hinge lever 32 until it engages behind the holding element 314 in a holding channel 3140.

FIG. 8b shows the first lever end piece 311 of the first hinge lever 31 of FIG. 8a with the holding element 314, which comprises an inclined flank or ramp 3141, and which adjoins the holding channel 3140, which is delimited on one side by the holding element 314 and on the other side by a preferably provided holding cam 315. It is illustrated that the schematically shown spring end piece 3411 is securely held within the holding channel 3140 between the holding element 314 and the preferably provided holding cam 315.

FIG. 9 shows an exploded view of the foldable-door hinge 3 and the bezel device 4 of FIG. 6a. Essential elements of the foldable-door hinge 3 have already been explained with reference to FIG. 5b of FIG. 6a. In FIG. 9, the outer bearing arms 3111, 3114 of the first lever end piece 311 of the first hinge lever 31 are provided with the preferably designed holding elements 314, which comprise a ramp.

The inner bearing arms 3112, 3113 preferably comprise bearing openings 31120, 31130 with an inwardly directed first bearing opening part 31120A, 31130A, whose diameter corresponds to the diameter of the hinge shaft 33, and an outwardly directed second bearing opening part 31120B, 31130B, whose diameter corresponds to the diameter of the bearing rollers 35. In this preferred embodiment, the bearing rollers 35 are therefore possibly rotatably held on both sides by an outer and an inner bearing arm 3111, 3112 or 3114, 3113 and are always aligned coaxially to the rotation axis x. The bearing pins 36 can be held in the first or second bearing opening part 31120A, 31130A; 31120B, 31130B or in an intermediate transition part or a receiving bore which is partially guided into the first bearing opening part 31120A, 31130A.

On the hinge shaft 33 there are also bearing pins 36 facing each other, which can engage in the bearing openings 3210 of the first lever end piece 321 of the second hinge lever.

The bearing rollers 35 and/or the bearing pins 36 are preferably made of metal, for example high-quality steel, or of a plastic, in particular a resistant and slidable plastic, for example a thermoplastic, such as POM/polyoxymethylene, which guarantees the optimum bearing of the hinge shaft 33 and/or the spring packets 341, 342 in the long term.

To prevent the hinge shaft 33 from moving axially by itself, it is preferably held pressed inside one of the bearing arms 3111, 3112, 3113, 3114 of the first hinge lever 31 or inside the first lever end piece 321 of the second hinge lever 32. However, other means such as retaining rings, in particular snap rings, may be provided to secure the hinge shaft 33. For example, a slot is provided in the first lever end piece 321 of the second hinge lever 32 into which a retaining ring 331 is inserted which can engage a circumferential groove 330 in the hinge shaft 33 to hold the hinge shaft 33 preferably loosely but not axially displaceably. In this case, the hinge shaft 33 can be inserted into both hinge levers 31, 32 and secured by means of only one retaining ring 331.

Furthermore, the bezel device 4 is shown with the bezel profile 41, which comprises two profile side pieces 412, which are connected to each other by a profile centrepiece 411. The bezel profile 41 comprises an approximately C-shaped cross-section and an internal cross-section which corresponds at least approximately to the cross-section of the holding modules 42. As illustrated, the holding modules 42 can be inserted into the bezel profile 41 so that they are held form-fittingly but axially displaceably therein and can be fixed by means of a threaded element 424, possibly a threaded bolt, which is screwed into the threaded bore 420.

The holding module 42 comprises a module body 421 with the threaded bore 420 and anchor elements 422 provided on both sides running parallel to each other. The anchor elements 422 can engage in the profile side pieces 412 of the bezel profile 41, which are preferably claw-shaped.

FIG. 10 shows the foldable-door hinge 3 and the bezel device 4 of FIG. 6a or FIG. 6b in the closed position of the foldable door 11, in which the door elements 111, 112 lie face to face and close the door gap between them. The bezel device 4 has been moved back behind the foldable door 11 by the hinge levers 31, 32 and is therefore no longer visible. Advantageously, only the foldable door 11 with the planarly aligned door elements 111, 112 in the closed position is presented to the viewer of the functional entity or of the piece of furniture 1. The functional entity 1 is therefore reliably closed and access between the door elements 111, 112 is no longer possible.

If an obstructing door gap remains, the mounting screws 391, by means of which the hinge levers 31, 32 are connected to the mounting elements 39, can be loosened and the mounting elements 39 can be moved relative to the hinge levers 31, 32 until the door gap has reached the desired dimension. It is illustrated that the left hinge cup 39 can be engaged with a screwdriver to achieve the desired displacement. Subsequently, the mounting screws 391 are tightened again.

FIG. 11 shows the foldable-door hinge 3 and the bezel device 4 of FIG. 10 with the door elements 111, 112 folded against each other, between which the bezel device 4, which is closing the gap, is held by the foldable-door hinge 3.

FIG. 12 shows the foldable-door hinge 3 and the bezel device 4 of FIG. 11 as seen from above. It can be seen that the stop elements 316, 326 hold the bezel profile 41 in the desired position. It can also be seen that the internal cross-section of the bezel profile 41 corresponds at least approximately to the cross-section of the inserted holding module 42, which is connected to the hinge shaft 33 by the retaining clip 423. Furthermore, it is shown that the spring centrepiece 343 of the drive spring 34 is held between the holding member 324 and the catch 325 of the second hinge lever 32.

### LIST OF REFERENCES

1 functional entity, piece of furniture, e. g., wardrobe
1A side walls
1B upper board
1C lower board
1D separation wall
10 first or second door compartment 10 or parking space
100 interior of the functional entity 1
11 foldable door
111 first door element
112 second door element
11′ one-part door
12 mounting profile
13 mounting hinges
15A support rail for the support carriage 5A
15B guide rail for the guide carriage 5B
151 support element
152 guide channel
2 holding device
20 magnetic or ferro-magnetic locking element
200 spacer plate
21 mounting part
22 holding lever
23 lever shaft
24 locking unit
241 force transmitter
242 switching mechanism
243 reset spring
25 coupling unit
28 holding magnet
29 spacer rollers
3 foldable-door hinge
31 first hinge lever
311 first lever end piece of the first hinge lever 31
3111 first bearing arm
3110 first bearing opening
3112 second bearing arm
31120 second bearing opening
31120A, 31120B second bearing opening parts
3113 third bearing arm
31310 third bearing opening parts
31310A, 31310B third bearing opening
3114 fourth bearing arm
31140 fourth bearing opening
312 second lever end piece of the first hinge lever 31
314 holding elements
3140 holding channel
3141 ramp, inclined flank
315 holding cam
316 first stop elements, stop lugs
32 second hinge lever
321 first lever end piece of the second hinge lever 32
3210 bearing opening in the first lever end piece 321
322 second lever end piece of the second hinge lever 32
324 holding member
325 catch
326 second stop element, stop lug
328 rest sink
33 hinge shaft
330 circumferential groove in the hinge shaft (optional)
331 retaining ring, e.g. snap ring, (optional)
34 drive spring
341 first spring packet
3411 first spring end piece
342 second spring packet
3421 second spring end piece
343 spring centrepiece
35 bearing rollers
350 axial bore
36 bearing pin
39 mounting part, hinge cup
4 bezel device
41 bezel profile
410 internal cross-section of the bezel profile 41
411 profile centrepiece
412 profile side pieces
42 holding module
420 threaded bore
421 module body
422 anchor elements
423 connection element, preferably retaining clip
424 threaded element, threaded bolt
5A support carriage
5B guide carriage
51 support rollers
52 guide rollers
53 first carriage body part
54 second carriage body part
9 displacement device
x rotation axis of the foldable-door hinge

1. A foldable-door hinge
with a first hinge lever, which comprises a first lever end piece with at least one bearing opening and a second lever end piece, which is connected or connectable to a first mounting part;
with a second hinge lever, which comprises a first lever end piece with at least one bearing opening and a second lever end piece, which is connected or connectable to a second mounting part;
with a hinge shaft which is held in the bearing openings of the hinge levers and which pivotably connects the two hinge levers to one another; and
with a drive spring, which on the one hand abuts the first hinge lever and on the other hand abuts the second hinge lever,
wherein the first lever end piece of the first hinge lever comprises two spaced apart first and second inner bearing arms with associated bearing openings between which the first lever end piece of the second hinge lever is held, and two first and second outer bearing arms spaced apart from the inner bearing arms, and
wherein the drive spring comprises two spring packets which enclose the hinge axis and which are interconnected by a spring centrepiece, which abuts the second hinge lever, and of which the first spring packet, which is arranged between the first inner bearing arm and the first outer bearing arm comprises, at an end remote from the spring centrepiece, a first spring end piece, which abuts the first outer bearing arm, and of which the second spring packet, which is arranged between the second inner bearing arm and the second outer bearing arm, comprises, at an end remote from the spring centrepiece, a second spring end piece, which abuts the second outer bearing arm, wherein
the first hinge lever comprises for each of the spring end pieces a holding element in which the associated spring end piece is engaged or can be engaged, or
that the second hinge lever comprises a holding member in which the spring centrepiece is engaged or can be engaged, or
that the first hinge lever comprises for each of the spring end pieces a holding element in which the associated spring end piece is engaged or can be engaged, and that the second hinge lever comprises a holding member in which the spring centrepiece is engaged or can be engaged.

2. The foldable-door hinge according to claim 1, wherein
the holding elements are designed as latching elements into which the spring end pieces can engage, or
that the holding member is formed as a latching element into which the spring centrepiece can engage, or
that the holding elements are formed as latching elements into which the spring end pieces can engage, and that the holding member is formed as latching elements into which the spring centrepiece can engage.

3. The foldable-door hinge according to claim 1, wherein the spring centrepiece is or can be held on the second hinge lever between the holding element and a catch.

4. The foldable-door hinge according to claim 1, wherein
the drive spring is coupled to the first hinge lever and is couplable to the second hinge lever by rotation of the hinge levers against one another; or
that the drive spring is coupled to the second hinge lever and can be coupled to the first hinge lever by rotation of the hinge levers against each other; or
that the drive spring can be coupled to the first hinge lever on the one hand and to the second hinge lever on the other hand by rotation of the hinge levers.

5. The foldable-door hinge according to claim 4, wherein
the first and the second outer bearing arm each comprise one of the holding elements which comprises a ramp via which the associated first or second spring end piece can be introduced into a holding channel located behind the holding element, in which holding channel the associated first or second spring end piece is held after the foldable-door hinge has been put into operation; or
that the first lever end piece of the second hinge lever comprises the holding member in the form of a latching element, over which the spring centrepiece can be guided and latched behind the holding member; or
that the first and the second outer bearing arm each comprise one of the holding elements which comprises a ramp via which the associated first or second spring end piece can be introduced into a holding channel located behind the holding element, in which holding channel the associated first or second spring end piece is held after the foldable-door hinge has been put into operation, and that the first lever end piece of the second hinge lever comprises the holding member in the form of a latching element, over which the spring centrepiece can be guided and latched behind the holding member.

6. The foldable-door hinge according to claim 1, wherein within the spring packets of the drive spring a bearing roller is held rotatably and substantially free of play by the hinge shaft, wherein the outer diameter of the bearing rollers is smaller than the minimum inner diameter of the spring packets.

7. The foldable-door hinge according to claim 6, wherein
the bearing openings of the first and second outer bearing arms comprise an inner diameter which allows one of the bearing rollers to pass through and into the associated spring packet, or
that the bearing openings of the first and second outer bearing arms comprise an inner diameter which allows one of the bearing rollers to pass through and into the associated spring packet and further into a bearing opening part of the adjacent first or second inner bearing arm.

8. The foldable-door hinge according to claim 1, wherein the spring packets of the drive spring comprise helical or thread-like turns which bear against one another or are at least partially spaced apart from one another from turn to turn, so that the spring packets can be compressed axially.

9. The foldable-door hinge according to claim 1, wherein the hinge shaft projects beyond the first hinge lever on one or both sides with an end piece, which end piece of the hinge shaft is connected to a bezel device.

10. The foldable-door hinge according to claim 9, wherein the bezel device comprises a bezel profile having two profile side pieces interconnected by a profile centrepiece, that at least one holding module is held within the bezel profile in a form-fittingly, displaceable and fixable manner, which holding module comprises a connection element which is fixedly or detachably connected to the hinge shaft.

11. The foldable-door hinge according to claim 10, wherein the first lever end piece of the first hinge lever is provided with at least one first stop element, and that the first lever end piece of the second hinge lever is provided with at least one second stop element, the first and second stop elements being arranged on the first and second hinge lever in such a way that they are aligned in opposite directions after rotation of the two hinge levers and form abutment surfaces for the bezel profile.

12. A functional entity, piece of furniture or room segment, with a foldable door with two door elements which are connected to one another by at least one foldable-door hinge according to claim 1.

13. The functional entity according to claim 12, wherein a bezel device is held by the foldable-door hinge, which is provided for covering a door gap between the door elements.

14. The functional entity according to claim 12, wherein the foldable door can be locked in a closed position by means of a holding device and can be released again from the closed position, wherein the foldable door can be at least partially transferred into the folded state by the action of force exerted by the foldable-door hinge or the foldable-door hinges.

15. The functional entity according to claim 12, wherein the first door element is connected at an edge remote from the foldable-door hinges by mounting hinges to a mounting profile which is displaceable within a door compartment of the functional entity and that the second door element is connected at an edge remote from the foldable-door hinges to a guide carriage which is guided in a guide rail extending along the front side of the functional entity.
